(19) United States
(12) Patent Application Publication
(10) Pub. No.: US 2020/0320198 A1
(43) Pub. Date: Oct. 8, 2020

(54) COMPONENT RECALL CHECKING

(71) Applicant: HEWLETT-PACKARD DEVELOPMENT COMPANY, L.P., Spring, TX (US)

(72) Inventors: Christopher H Stewart, Houston, TX (US); Jeffrey P Kenline, Houston, TX (US); Brandon Huber, Houston, TX (US); Robert Stephen Craig, Houston, TX (US); Virupakshi Channagiri, Houston, TX (US); Jon G Lloyd, Houston, TX (US); Rosilet Braduke, Houston, TX (US); Lan Wang, Houston, TX (US); Hsin-Ming Yang, Taipei (TW)

(21) Appl. No.: 16/481,087

(22) PCT Filed: Dec. 19, 2017
(86) PCT No.: PCT/US2017/067305

§ 371 Date: Jul. 26, 2019

(51) Int. Cl. G06F 21/57; G06F 13/20

(52) U.S. Cl. CPC G06F 21/57; G06F 13/20

(57) ABSTRACT

An example device comprises a plurality of components and a BIOS includes a non-volatile memory having instructions stored thereon that are executable by a processor of the device to cause the BIOS to determine a component identification (ID) of a component of the plurality of components, and fetch a plurality of recall component IDs. The instructions also are to cause the BIOS to compare the determined component ID with the plurality of recall component IDs. In response to a correspondence between the determined component ID and one recall component ID of the plurality of component IDs, the BIOS is to transmit signals representing a prompt to place the component of the plurality of components in a safety mode. The instructions also cause the BIOS to receive signals in response to the prompt and, responsive to the received signals, disable the component of the plurality of components.

### BACKGROUND

Devices may include components, such as batteries, integrated circuits (ICs), controllers, fans, belts, pulleys, airbags, etc. For a number of reasons, components may be considered to be defective. Components may not be manufactured according to established standards; components may not operate as expected; components may fail too quickly; etc. As such, there may be a desire to remove devices and/or components from use. At times, therefore, device components may be subject to recalls. Users may be notified of recalls using mass mailings (e.g., electronic or via mail), by way of non-limiting example.

### BRIEF DESCRIPTION OF THE DRAWINGS

Various examples will be described below by referring to the following figures.

FIG. 1 is block diagram of an example device;

FIG. 2 is flow diagram for an example method of initiating a safety mode of operation;

FIG. 3 is a block diagram of an example device in an example system;

FIG. 4 is a flow diagram for an example method for identifying components subject to a recall;

FIG. 5 is a flow diagram of an example method for starting a BIOS; and

FIG. 6 is a flow diagram of an example method for identifying components subject to a recall.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

As noted above, devices, such as computing devices, may include components that do not meet desired standards, such as quality standards, of a manufacturer. Additionally, components may be otherwise faulty or defective. The inclusion of such components may thus be undesirable due to a potential to cause harm to the device, to property, or to users, for example. Additionally, the goodwill of the manufacturer may be harmed by the inclusion of such faulty or defective components in a device. For instance, a computing device may include a battery that may not operate consistently with established standards for the component. For instance, it may overheat, it may not charge as desired, it may not hold a charge as desired, etc. There may therefore be a desire to replace the battery. A recall is one method for removing faulty and defective components from the marketplace and/or user possession. However, notifying parties affected by a recall may present certain challenges.

By way of example, some methods for notifying users of a recall may be ineffective for causing users to undertake and follow through on a recall procedure. For instance, users that receive mailed notifications of recall may elect to disregard the notification due to a number of possible reasons including, by way of example, the number of user actions called for (e.g., contacting support, travelling to a repair center, etc.) or the inconvenience of those actions. For example, recall notices that request that users package and ship a device containing a component subject to recall may be seen as onerous and users may elect to disregard the recall notice at the risk of damage to the device, to the user, or to personal property, by way of example. There may thus be a desire for an approach that facilitates component recall, potentially reducing a burden of the recall, and/or otherwise increasing a probability that users follow instructions associated with a recall notice.

A likelihood that users follow recall instructions may be increased through use of machine-executable instructions to provide persistent notifications and reminders at a device. In one case, signals representing machine-executable instructions for recall identification and notification may be transmitted to a device via a connection to a network, such as a public or wide-area network (WAN) like the Internet. The signals may be received by an operating system (OS) of the device (e.g., Windows or OSX for computing devices). The signals may cause the device to determine whether a component subject to recall is installed in the device, and, responsive to an identification of such a component, cause a prompt to be displayed to users of the device, such as on a display. The prompt may include directions to enable replacement of the component subject to recall.

There may be a desire, however, to have recall detection and notification be performed other than by an OS of a device, such as due to potential security and/or user manipulation concerns. Transmitting signals to enable recall identification and notification may not be readily apparent, however, such as while maintaining desired levels of security and user friendliness.

There may also be a desire to be able to continue to use a device, such as for a period of time, after receiving a recall notification. For example, if a fan of a computing device is determined to be subject to a recall there may be a desire to continue to use the computing device for a period of time until the computing device or the fan can be transmitted for service. In one case, such functionality may be achieved by operating a processor of the computing device at a lower frequency, by way of example, and/or otherwise reducing an amount of heat generated by other components of the computing device. Also, other fans of the computing device may be operated to compensate for a defective fan. In yet another example, if a battery is determined to be subject to recall, the battery may be disabled and discharged while still allowing the device to operate using a different power source (e.g., AC power).

In one example, identifying and handling of component recall may be handled by an executable program loaded from non-volatile memory of a device and executed by a processor of the device to provide an interface between an OS of the device and the hardware and/or firmware of the device. In the context of a computing device, for example, the interface program may comprise a Basic Input/Output System (BIOS) which may be loaded by a chipset processor (e.g., an embedded controller (EC)) from non-volatile memory of the computing device. The BIOS may enable hardware component testing and verification and may facilitate loading of a (primary) OS from a device memory. Thus, in a computing context, a sample BIOS may refer to a BIOS of a personal computer (PC), another example BIOS may refer to an Extensible Firmware Interface (EFI) of a device, such as an EFI of a Mac computer by Apple Inc. or an IBM-compatible PC, another example BIOS may refer to a Unified Extensible Firmware Interface (UEFI) of a PC, and like interfaces to be developed in the future. At times, a BIOS may be alternatively referred to as a bootloader. For example, Raspberry Pi may use a GPU-based bootloader as a BIOS, and Android devices, iOS devices, and Tizen devices may also use a bootloader. Furthermore, devices used in automobiles may also use a BIOS. For simplicity, all such executable programs loaded from non-volatile memory and providing an interface between an OS and hardware/firmware are referred to as a BIOS. It should therefore be apparent that a BIOS may be used in a number of devices including and/or present in electronic devices, appliances, and vehicles, by way of non-limiting example.

In one case, identifying and handling (e.g., providing a response to) component recall may be performed in response to installation of an updated BIOS on a device. In such a case, executable instructions for an updated BIOS may include a list of recall component identifications (IDs). The updated BIOS executable instructions may also include instructions for a recall identifying and handling routine. For example, and as shall be discussed in greater detail herein, the routine may be capable of determining a presence of components subject to recall. The routine may also be capable of entering a safety mode in response to detection of a component subject to recall. By way of illustration, an updated BIOS may be installed on a vehicle, and, responsive to execution of a recall identifying and handling routine by the updated BIOS, it may be determined that an airbag of the vehicle may be subject to recall. The BIOS may thus facilitate initiation of a safety mode corresponding to the component subject to recall. For example, if the airbag subject to recall is to be replaced (e.g., because of over-inflation of the airbag), then a safety mode of operation may include limiting an inflation pressure of the airbag and programming a nearest service center into the navigation system to direct the vehicle to a resource for recall assistance. As such, provision of recall identifying and handling in a BIOS update (e.g., including recall component numbers hard-coded into a BIOS) may provide desired levels of security and user friendliness.

In another implementation, rather than installing an updated set of executable instructions for a BIOS with a list of recall component IDs included therein, a BIOS may include a recall identifying and handling procedure that may be capable of receiving a signed data packet that may be authenticated by the BIOS. The signed data packet may include recall component IDs. In one case, the signed data packet may be received via a private network, a public network, or connected physical media. However, it may be desirable to use a method of authentication in order to confirm a source of the signed data packet, such as to avoid malicious access to hardware, firmware, and/or BIOS of a device.

Once the signed data packet is received by the BIOS, recall component IDs included therein may be used in order to determine a presence of components subject to a recall and to provide handling of the device in view of the recall. For example, and as noted, in some cases the device may be able to continue to operate in a safety mode after identifying a component subject to recall. In other cases, however, the device may not be able to continue operation, such as at times at which a safety mode may not adequately reduce risk of harm and/or damage. For example, in cases of mobile devices with embedded batteries that may spontaneously combust, a recall identifying and handling procedure may determine that the device should not be able to operate, such as to avoid harm to the device, users, and other property.

As should be apparent based on the foregoing description, a recall identifying and handling procedure may be desirable in a number of contexts. By way of example, it may be desirable for computing devices (e.g., desktop computers, workstations, laptops, tablets, mobile phones, etc.) to be capable of identifying components that are subject to a recall. In the case of electronics, such as televisions, media devices, and Internet of Things devices, there may also be a desire to be able to identify components subject to a recall and handle recall operations (e.g., instructing users as to how to proceed, notifying manufacturers, etc.). Other example contexts may include, but are not limited to, appliances (e.g., refrigerators, washing machines, vacuums, etc.) and vehicles (cars, trucks, buses, planes, etc.), without limitation.

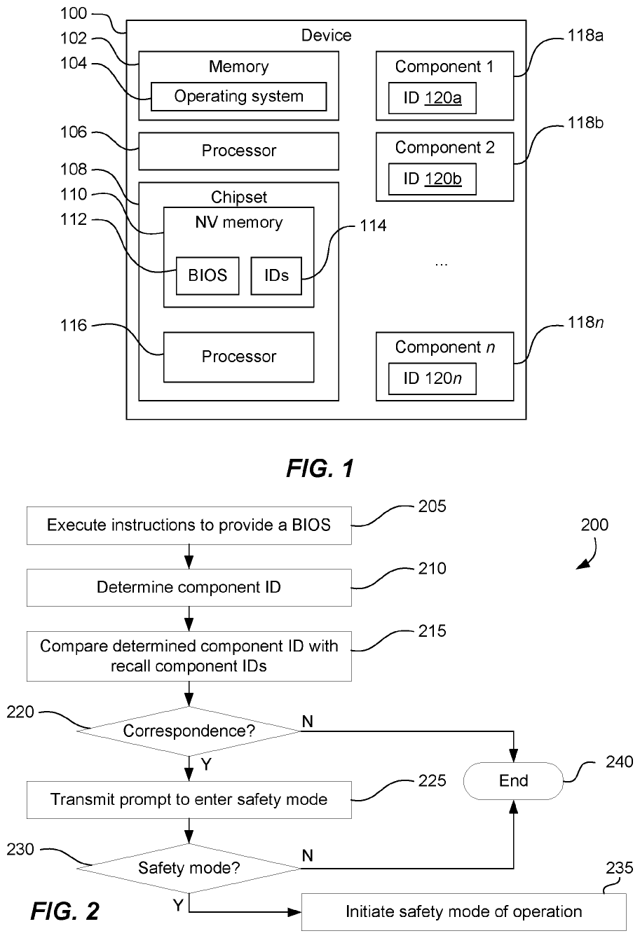

To illustrate, FIG. 1 shows a sample device 100 for which there may be a desire to identify components subject to recall and to perform recall handling. Device 100 may comprise, for instance, a computing device. In another case, device 100 may form an element of a subsystem of a system. For instance, an automobile may be composed of a number of subsystems. Among other things, the automobile may comprise a number of computing systems (e.g., a system to monitor engine operation, a system to handle navigation, a system for electronically-assisted steering, a system for electronically-assisted braking, etc.). Device 100 may be an element in one or more of the systems or subsystems of the automobile. Thus, in the context of such possible implementations, it may be desirable to identify components of device 100 that may be subject to a recall, and it may also be desirable to provide a mode of operation of device 100 to facilitate handling of the recall.

Turning to FIG. 1, an example device 100 may comprise a memory 102, an OS 104, which may be stored as executable instructions within memory 102, and that may be executed by processor 106. In some cases, device 100 may comprise a chipset 108 comprising a non-volatile memory 110 in which may be stored executable instructions, such as executable instructions for a BIOS 112, which may be executed by processor 116 (e.g., an EC). Recall component IDs 114 may also be stored in non-volatile memory 110 (e.g., included within executable instructions for BIOS 112).

In one implementation, memory 102 may comprise forms of processor-readable memory such as random access memory (RAM), read-only memory (ROM), non-volatile memory (NV memory), flash memory, resistive memory (e.g., phase change memory), hard disk drive memory, solid state memory, and optical memory (e.g., digital versatile disc (DVD)), by way of illustration. Memory 102 may enable storage and retrieval of data (e.g., signals or states, such as stored as binary ‘1’s and ‘0’s in a binary digital implementation). Memory 102 may be in communication (e.g., electrical communication) with processor 106 via a bus, such as an electrical bus. In one implementation, a bus connecting memory 102 and processor 106 may also enable communication between other components of device 100. For example, in one case, processor 106 may be capable of communicating (e.g., exchanging signals) with chipset 108 and components 118a-118n via the bus. It is noted that memory 102, processor 106, and chipset 108 (along with NV memory 110 and processor 116) are also example components. For clarity of description, they are specifically mentioned by name herein. However, recall identifying and handling processes may also apply to them as well as to other components of device 100, such as components 118a-118n.

In one implementation, device 100 may use a plurality of operating systems in order to control and manage exchange of signals between components of device 100. In one case, for example, a first OS (e.g., in some cases, BIOS 112 may compose a portion of the first OS, in other cases, BIOS 112 may operate in conjunction with the first OS) may comprise a program operating at a low level in the software stack (e.g., coordinating signal exchange between hardware components, firmware, etc. but not necessarily application layer executable instructions). The first OS may be started in response to execution of executable code stored in non-volatile memory 110.

In this case, a second OS, referred to herein alternatively as a “primary” OS 104, may enable coordination of signal exchange between hardware components, firmware, the first OS, and/or applications operating at the application layer of the software stack. OS 104 may comprise a Unix-based OS, a Linux-based OS, a Windows-based OS, an OSX-based OS, a mobile device OS (e.g., an iOS-based OS, an Android-based OS, etc.), and a QNX-based OS, by way of non-limiting example.

Executable instructions, such as for an OS or a BIOS, may be executed by a processor. Processor 106 comprises an example processor capable of interpreting and executing instructions. Processor 116 comprises another example processor capable of interpreting and executing instructions. In one implementation, processor 116 may be capable of providing support for processor 106 and/or OS 104. Processors 106 and 116 may comprise circuit elements, such as transistors, to enable interpreting and executing instructions. In one implementation, processor 116 may comprise an application-specific integrated circuit (ASIC).

Example chipset 108 may comprise a set of electrical components, such as processors (e.g., processor 116) including ASICs, memory (e.g., NV memory 110), etc. to manage transfer of signals between, for example, processor 106, memory 102, and components 118a-118n. Chipset 108 may be used in one implementation to identify and handle recall procedures, as shall be described hereinafter.

FIG. 2 is a flow chart illustrating example operation of elements of FIG. 1 according to one example method 200. At block 205, instructions may be executed (e.g., by processor 116) to provide a BIOS, which may provide an interface between a primary OS and firmware and/or hardware of device 100. For example, referring back to FIG. 1, executable instructions may be stored in NV memory 110 and may be executed by processor 116 in order to provide a BIOS 112. Among the functionality provided by BIOS 112, BIOS 112 may be capable of identifying components of device 100 that may be subject to recall. Further, BIOS 112 may be capable of responding to recall (e.g., altering operation of device 100 to be in a safe mode of operation, facilitating replacement of components subject to a recall, etc.). For example, upon boot up of device 100, BIOS may be capable of running an initial recall check routine.

Returning to example method 200 of FIG. 2, as shown at block 210, BIOS 112 may be capable of determining a component ID for a component of the device. Referring back to FIG. 1, for example, BIOS 112 may be capable of identifying an ID 120a of component 1 118a, an ID 120b of component 2 118b, and an ID 120n of component n 118n. In one implementation, a component ID of a device may be hard-coded into the component, such as at a time of manufacture. Thus, BIOS 112 may be capable of transmitting a request for a component ID, such as to components 118a-118n, and in response a component ID may be transmitted to BIOS 112. In another case, upon installation of components 118a-118n in device 100, information relating to components 118a-118n (e.g., a component ID) may be stored in a memory, such as memory 102, NV memory 110, or another memory, by way of non-limiting example.

Returning to example method 200, as shown at block 215, the BIOS may compare the determined component ID with a plurality of recall component IDs. Referring back again to FIG. 1 and example device 100, BIOS 112 may be able to fetch a plurality of recall component IDs, such as recall component IDs 114, which may be stored in a memory, such as NV memory 110. For example, in one case, recall component IDs 114 may be stored on NV memory 110 upon installation of BIOS 112 or installation of an update of BIOS 112. In an alternative implementation, recall component IDs 114 may be stored upon reception of a signed (e.g., authenticated) blob, such as via a Windows Management Instrumentation (WMI) interface. In yet another case, recall component IDs 114 may be received externally to device 100, such as via a network interface.

BIOS 112 may compare the component ID determined at block 210 with the plurality of recall component IDs. In one case, there may be a correspondence between the determined component ID and a recall component ID of the plurality of recall IDs. For example, the determined component ID and a recall component ID may match in whole or in part. For example, in one case, if an entire group of components are subject to recall and have component IDs that span a series of consecutive IDs (e.g., xxxx00-xxxx99), then a portion of the determined component ID may correspond to a common string of characters from the plurality of recall IDs (e.g., xxxx15).

At block 220 of FIG. 2, if a correspondence is not identified between a component ID and a recall component ID, then example method 200 may end, as shown by block 240. Ending example method 200, as shown by block 240, may comprise continuing with a boot up of a device, for example (or other appropriate action according to a particular context). If a correspondence is identified, however, then example method 200 may continue to block 225.

At block 225, in response to a correspondence between the determined component ID and one of the plurality of recall component IDs, signals representing a prompt may be transmitted, such as to a display, to prompt entry of a safety mode. For example, in an implementation in which device 100 comprises a computing device, signals enabling display of objects (e.g., text, interactive elements, etc.) may be transmitted to a display of device 100. The prompt may notify of a recall, of a component affected by the recall, provide instructions to facilitate repair and/or replacement of the recall-affected device, etc. In one case, the prompt may request user approval to enter a safety mode. For example, it may be desirable to allow a user to opt-in to a safety mode of operation. In a case in which a component subject to a recall comprises a battery, for instance, the prompt may inform the user of the recall, provide instructions to facilitate repair/replacement of the battery, and may prompt the user to place the device and/or battery in a safety mode. The prompt may inform the user, for instance, that in safety mode the computing device may be used when plugged into a source of power (e.g., an AC outlet), but that the safety mode will disable and discharge the battery. The prompt may ask the user to opt-in to the safety mode of operation.

At block 230, if it is determined that the user has declined to start the safety mode of operation, then example method 200 may end, as shown at block 240. In contrast, if signals are received responsive to the prompt indicative of approval for entry into safety mode, then method 200 may progress to block 235. At block 235, in response to reception of signals received from the prompt, a safe mode of operation may be initiated. Referring back to FIG. 1, for example, BIOS 112 may be capable of placing a component, such as components 118a-118n in a safety mode of operation, or facilitating placement of a component in a safety mode of operation, such as via chipset 108. In the case of a battery, for example, safety mode may comprise disabling and discharging the battery. In the case of a fan, safety mode may comprise compensating for reduced thermal dissipation capacity by, for example, increasing a fan speed of remaining fans, decreasing an operating frequency of processors of a device, and the like.

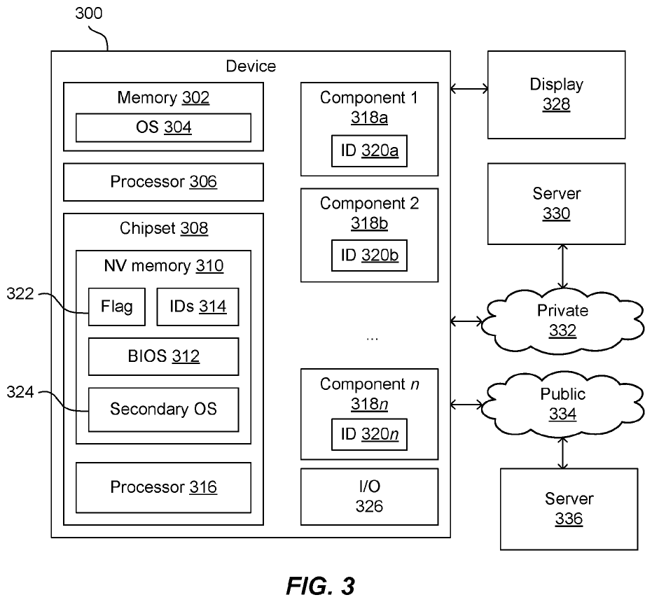

FIG. 3 illustrates an example device 300, which may have elements that are similar and/or analogous to those shown in example device 100 of FIG. 1. For example, device 300 may comprise a memory 302, a processor 306, a chipset 308, and components 318a-318n, which may be similar to elements of device 100. Chipset 308 may comprise an example NV memory 310 and an example processor 316 (e.g., an EC), which may be similar to chipset 108, NV memory 110, and processor 116, of device 100. Additionally, device 300 may comprise an I/O element, which may provide an interface to peripheral devices (e.g., display 328) and networks, such as private network 332 and public network 334, by way of example. It is noted that I/O 326 may be composed of a plurality of different components (e.g., a network controller, a display controller, etc.) and is illustrated by a single element for simplicity. In fact, I/O 326 may comprise component IDs, and may be checked against a list of recall component IDs in one implementation. As used herein, I/O 326 refers to a component to enable exchange of data packets between device 300 and external devices and peripherals.

Display 328 comprises a mechanism capable of displaying, for example, prompts related to a recall, such as discussed above in conjunction with block 225 of example method 200 in FIG. 2.

Returning to FIG. 3, chipset 308 is illustrated with instructions stored in NV memory 310 for a secondary OS 324 and a flag variable 322 in addition to recall component IDs 314 and BIOS 312. In the example of device 300, primary OS 304 is similar to OS 104 and secondary OS 324 is similar to the first OS discussed above in relation to FIG. 1. Flag variable 322 refers to data storable in a memory, such as NV memory 310, to indicate, for example, a safety mode of operation.

As discussed above, in operation, device 300 may be capable of identifying components that may be subject to a recall. Upon boot up, device 300 may execute instructions stored in NV memory 310 to initiate a BIOS 312. BIOS 312 may compare component IDs, such as component IDs 320a-320n, of components 318a-318n with recall component IDs 314 stored in memory, such as NV memory 310. If BIOS 312 determines that the component IDs do not correspond to recall component IDs 314, then instructions for OS 304 may be executed, such as by processor 306, to load OS 304. On the other hand, if BIOS 312 does identify a component of device 300 that correspond to a recall component ID of recall component IDs 314, then BIOS 312 may facilitate entry of a safety mode. In one case, for example, BIOS 312 may identify a component (e.g., component 1 318a) that may be subject to recall. BIOS 312 may trigger a safety mode, which may comprise, for example, disabling component 1 318a, such as to not provide a communication channel between component 1 318a and other components of device 300 (e.g., processor 306). A safety mode of operation may comprise other aspects, such as battery discharge in a case in which a battery is subject to recall, load balancing in a case in which a fan is disabled, pressurization controls in a case in which an airbag is subject to recall, etc.

In one case, recall component IDs, such as those stored in NV memory 310 in FIG. 3, may be fetched from an external source. For example, FIG. 3 illustrates example device 300 connected to a server 330 connected to device 300 over a private network 332, and a server 336 connected to device 300 over a public network 334. In an interest of security, device 300 may be capable of authenticating a source and/or contents of a list of recall component IDs received from an external source (e.g., server 330 or server 336). In one case, such authentication may be achieved by reception of executable instructions for an updated BIOS (e.g., to update BIOS 312), which may include recall component IDs encoded therein, to be received from an authenticated server (e.g., server 330 or 336) via one of private network 332 or public network 334. In another case, a signed blob may be received from server 330 or server 336 and based on a digital signature (or like authentication technique) recall component IDs from the signed blob may be referred to by BIOS 312 and/or stored to NV memory 310.

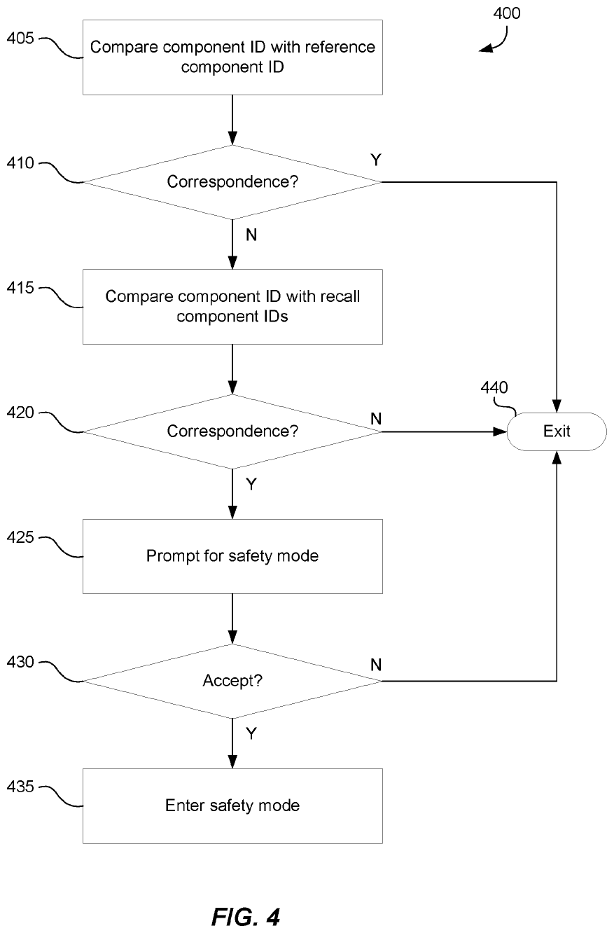

Example operation of device 300 may be described in conjunction with example method 400 of FIG. 4. As discussed above in conjunction with example method 200, a method of identifying components subject to recall may run upon each boot up of a device. It may be desirable, however, to reduce a frequency at which the method might be run. In one implementation, this may be achieved by storing component IDs for components that may have already been determined to not be subject to a recall (the stored component IDs being referred to as reference component IDs herein). Of course, in one case, stored reference component IDs may be cleared subsequent to an update of a BIOS or reception of a new list of recall component IDs, for example, such as to have components cleared against new recall component ID values. At block 405, BIOS 312 may compare a component ID with a reference component ID. This reference component ID may be stored in a memory, such as in memory 302 or NV memory 310, by way of non-limiting example.

If there is a correspondence between a component ID and a reference component ID, as shown by block 410, then example method 400 may end (block 440). To illustrate, for an example battery recall method, upon a first boot up process, a BIOS may determine that a battery is not subject to recall. The component ID for the battery may be stored to a memory (e.g., as a reference component ID). As such, in subsequent boot ups, it may be determined that the battery has already been tested against a current list of recall component IDs, and may therefore exit the recall identification method, thus potentially providing a quicker boot up process (e.g., as compared with a full recall identification and handling procedure).

If, however, it is determined, as shown at block 410, that there is no correspondence between a component ID and a reference component ID, then method 400 may advance to block 415. Similar to block 215 of example method 200, as shown at block 415, a component ID may be compared with a recall component ID, such as recall component IDs 314 of device 300 in FIG. 3. As noted above, recall component IDs 314 may be stored within NV memory 310 as part of a BIOS update or reception of a signed blob from an external source, such as from server 330 or server 336, by way of example.

If no correspondence is determined between a component ID and recall component IDs, then as shown at block 420, method 400 may end (e.g., exit as shown by block 440). An end or exiting of method 400 may include continuing a boot up process, such as executing instructions to launch a primary OS 304, by way of example.

In a case in which a correspondence is found between a component ID and a list of recall component IDs, then as shown at block 425, a prompt may be transmitted (such as to display 328 of example device 300 in FIG. 3). Example prompts may include a recall notification, an explanation of the recall, actions that may be taken, a URL to visit, an interactive element for a user to select in order to enter a safety mode of operation, etc.

In a case in which a user is prompted to enter a safety mode of operation, it may be determined, such as shown at block 430, that signals are received indicating an acceptance of a safety mode prompt. For example, if users are prompted to press a button, then as shown at block 430, signals may be received representing the button press. Etc.

Responsive to the acceptance of a prompt to enter a safety mode of operation (e.g., block 430), block 435 illustrates entry of the safety mode. As noted, details of a particular safety mode may vary depending on a particular component and a particular device. For example, in the context of a computing device, a recall method to identify a battery subject to recall may allow the computing device to still operate on AC power (or some other source of power) while also disabling and discharging the battery. In contrast, in the context of a vehicle, a recall method to identify a battery subject to recall may not allow the vehicle to operate as part of a safety mode of operation. In another example in the context of a vehicle battery, safety mode may allow the vehicle an ability to travel a limited distance for the recall, by way of further example.

In contrast to the foregoing, if a prompt to enter a safety mode is not accepted, then the process may end (e.g., as shown at block 440) and a boot up of the device may continue (e.g., such as by launching an OS). In such situations, however, upon subsequent boot up routines, the user may again be prompted to enter a safety mode of operation.

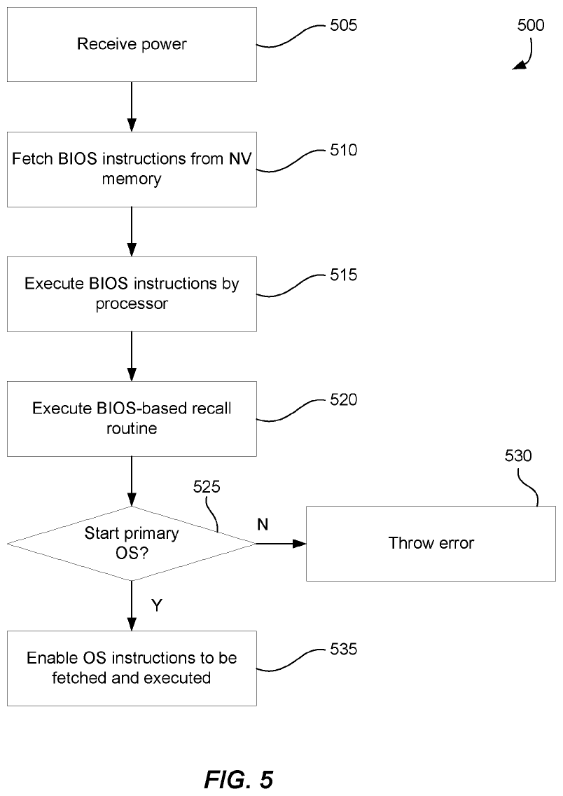

In the foregoing discussion, a boot up method of a device is referenced including, for example, a boot up of BIOS 312 in example device 300 of FIG. 3. FIG. 5 illustrates an example method 500 for booting up a device, and shall be described referring back to FIG. 3. At an example block 505, power may be received, such as at a chipset of a device (e.g., chipset 308 of device 300). This may comprise transmitting power from a power source (e.g., a battery, a power supply, etc.) to a chipset, such as in response to a button press, by way of example.

In response to power being received at a chipset, instructions may be fetched from a NV memory (e.g., NV memory 310 in FIG. 3). Thus, as already discussed above, instructions fora BIOS, such as BIOS 312 of device 300 of FIG. 3, may be stored in a memory of a device. As shown at block 510, the executable instructions for a BIOS may be fetched from the NV memory. The executable instructions for a BIOS may include a list of recall component IDs incorporated therein (e.g., hard-coded recall component IDs). And, subsequent to reception of executable instructions encoding an updated BIOS, the BIOS (e.g., executable instructions) may be updated with an updated list of recall component IDs. Thus, if executable instructions for a BIOS have been updated, as shown at block 510, the updated BIOS executable instructions may be fetched.

Moving on, as shown at block 515, the fetched executable BIOS instructions may be executed by a processor (e.g., processor 316 of example device 300 of FIG. 3). For security, among other things, it may be desirable to execute BIOS instructions by a processor other than a central processor of a device. For example, an ASIC (e.g., an EC) of a device may enable communication of data between different components of a device, and executable instructions for a BIOS may be executed by the ASIC in order to provide desired functionality.

At block 520, as part of the BIOS, a set of executable BIOS instructions may be executed in order to identify components subject to recall. Different implementations of recall identification have been described (e.g., example method 200 and example method 400) above by way of illustration, but not limitation.

Moving to block 525, a determination may be made as to whether or not a primary OS (e.g., OS 304 of example device 300 in FIG. 3) may be started. In some cases, for example, it may be determined that a device should not start a primary OS. For instance, if a device should not be operated in light of a recall, then upon starting a safety mode of operation, a device (e.g., chipset 308 of device 300) may not allow a primary OS (e.g., OS 304) to start. Further, it may be desirable to provide a user-friendly notification of an error may be presented, as shown at block 530 (e.g., informing users that OS may not be loaded in light of a recall).

However, if it is determined that an OS may be started, then as shown at block 535, the BIOS may enable fetching and execution of executable instructions for a primary OS. Thus, one implementation of example method 500 may include loading an OS of a device in response to signals received in response to a prompt, as discussed above in relation to block 425 of example method 400 in FIG. 4.

Furthermore, it may be desirable to communicate signals indicative of the battery safety mode to the primary OS, such as via a WMI. For example, the primary OS may be able to provide additional information regarding the recall, and may be able to direct the user to a URL and/or information regarding the recall, by way of illustration.

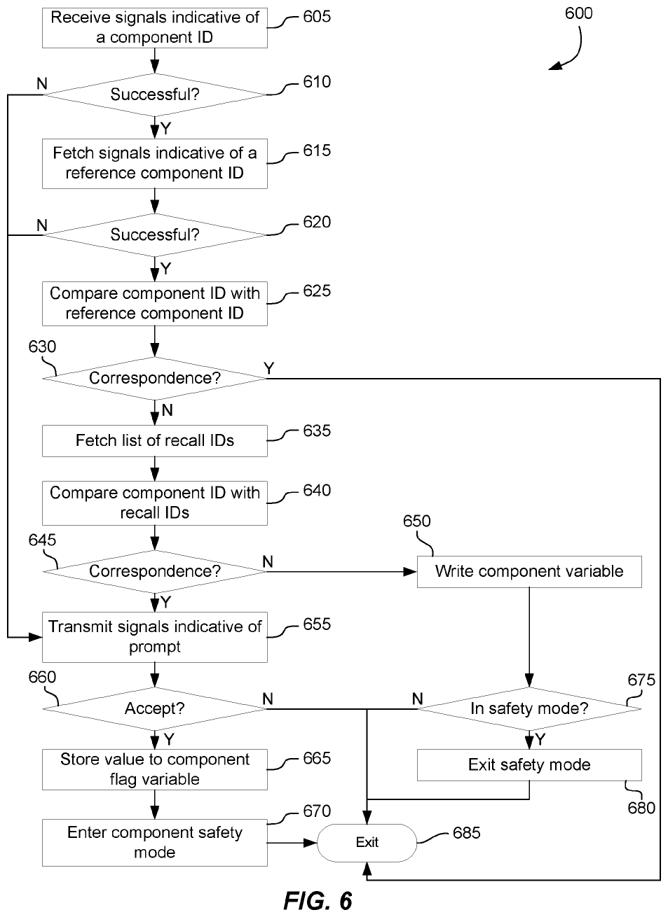

FIG. 6 illustrates another example method, method 600, for identification and handling of components subject to recall. Specifically, example method 600 is directed to an implementation of determining whether a battery of a device is subject to a recall. It should be understood, however, that this example is not to be taken in a limiting sense. Indeed, some aspects of example method 600 may be applicable to other contexts, as shall be apparent in the following discussion.

Thus, and to again use example device 300 to illustrate operation, instructions stored in a NV memory (e.g., NV memory 310 in FIG. 3) may be executed using a processor (e.g., processor 316 in FIG. 3). Execution of the executable instructions may initiate a routine or process of a BIOS (e.g., BIOS 312 of FIG. 3) that provides an interface between a primary OS (e.g., OS 304 of FIG. 3) and hardware and/or firmware of the device (e.g., device 300).

In response to the execution of the instructions, the BIOS may receive signals indicative of a component ID, as shown at block 605. The signals may allow the BIOS to determine an ID of a component, such as an ID of a battery of a device, by way of example. It may be desirable to include logic to cover cases in which a component ID may not be determined. For instance, as shown at block 610, a determination is made whether a component ID was successfully obtained. In one case, an inability to determine a component ID may be handled by sending signals indicative of a prompt (see, e.g., block 655 of method 600). In another case, signals conveying an error message may be transmitted to a display (e.g., display 328 of FIG. 3).

However, if it is determined that a component ID has been successfully identified, then as shown at block 615, signals may be fetched indicative of a reference component ID. As discussed above, it may be desirable to avoid unnecessarily checking a particular component against a list of recall component IDs upon each boot up. Therefore, in one implementation, it may be possible to store to a memory a component ID of a component not subject to a recall. This stored reference component ID may be referred to upon boot up and if it corresponds to a component ID determined at block 605, then it may be desirable to exit the recall check routine. As such, it may be desirable for a BIOS to fetch a reference component ID (e.g., a battery reference ID) stored in a memory, such as a NV memory, the reference component ID corresponding to a component ID determined previously (e.g., upon a previous boot up procedure).

If the BIOS is unsuccessful in fetching a reference component ID then in one case, a prompt may be transmitted to a display (e.g., display 328), as shown at block 655. In another case, rather than transmitting a prompt, an error may be noted and sent to a user. Etc.

However, assuming that the reference component ID was successfully fetched (or that no reference component ID was stored), as shown at block 625, the component ID determined at block at 605 with the reference component ID determined at block 615 as part of example process 600 executed as part of the BIOS executable instructions. And if no reference component ID was stored (e.g., such as upon an initial boot up after receiving a new list of recall component IDs), then the determined component ID may be compared with an empty string, for example.

If it is determined that there is a correspondence (e.g., a match in whole or part) between a determined component ID and a reference component ID, such as shown at block 630, then method 600 may exit the BIOS recall routine illustrated by method 600 (e.g., block 685).

Exiting example method 600 if a correspondence is determined at block 630 may occur in an implementation in which a component ID is stored as a reference component ID upon entry of a safety mode (e.g., block 670). However, if component IDs that correspond to entries on a list of recall component ID are not stored as reference component IDs, then upon finding a correspondence (e.g., block 630) it may be desirable to determine whether a device is already operating in a safety mode (not shown in FIG. 6). For example, in one example case, a device may have a first battery that is determined to not be subject to a recall. The ID of the battery may be stored as a reference component ID. However, if the first battery is exchanged in favor of a second battery that is subject to a recall, the device may subsequently be placed in a safety mode. Subsequently, if the second battery is removed and replaced with the first battery, then it may be desirable for the BIOS to recognize the first battery and withdraw the device from operating in the safety mode. Thus, a determination may be made (e.g., as shown at block 675) as to whether a device is operating in a safety mode. This determination may be made based on a component flag variable, which will be discussed hereinafter with reference to block 665. If the device is operating in a safety mode, then as shown at block 680, the device may exit the safety mode prior to exiting the routine (e.g., block 685).

However, returning to block 630, if it is determined that there is no correspondence between the determined component ID and the reference component ID, then method 600 may move on to block 635, at which point the BIOS may fetch a list of recall component IDs. In one case, the fetched recall component IDs may be stored in a NV memory (NV memory 310).

At block 640, the determined component ID may be compared with the fetched recall component IDs. Thus, in the case of a battery recall method, the BIOS may compare a determined battery ID with recall battery IDs contained in a list of recall battery IDs.

If there is no correspondence between the determined component ID and the recall component IDs (e.g., block 645), then method 600 may proceed to block 650, at which point, the determined component ID may be stored to memory, such as a reference component variable. The memory to which the component ID may be stored may comprise a NV memory, for example, such as NV memory 310 discussed above in relation to FIG. 3, or another memory of the device. Subsequently, method 600 may proceed to blocks 675, 680, and 685, as discussed above. An example of one such case may comprise installation of a new battery as part of a recall process, subsequent to which, a safety mode may be exited upon confirmation that the new battery is not on the recall component ID list.

However, if there is a correspondence between the determined component ID and a recall component ID (e.g., block 645), then method 600 may proceed to block 655 to transmit signals indicative of a prompt. For example, in the context of a recall check for a battery of a device, in response to a correspondence between the determined battery ID and one recall battery ID of the list of recall battery IDs, the BIOS may transmit signals representing a prompt to enter a battery safety mode, such as shown at block 655.

As noted above, a prompt may take a number of possible forms. One example form may include a notification or an instructions regarding the recall. Another example prompt may include a URL for recall-related information. Yet another prompt may include an interactive element (e.g., a button) that may be interacted with, such as to agree to place the device in a safety mode of operation.

As shown at block 660, if a prompt to enter a safety mode of operation is declined, then the process may exit the recall routine, as shown by block 685. Of course, in subsequent boot ups, the user will again be prompted to enter a safety mode of operation. If, on the other hand, the prompt to enter the safety mode of operation is accepted, then the device may enter the safety mode of operation.

In one case, entering a safety mode of operation may comprise storing to memory a value to a component flag variable, as shown at block 665. In one case, this value may comprise a single bit stored in memory to indicate that a safety mode of operation is being used. In another case, the component flag variable may comprise other signals, such as a component ID, by way of example. It is noted that as discussed herein, it may be the BIOS (and executable instructions of the BIOS) that may cause activation of a flag (e.g., a variable) indicating a safety mode.

Moving to block 670, the BIOS may enable entry of a component safety mode. For example, in one case, signals may be received, such as from a user, in response to the prompt of block 655 indicative of acceptance of a safety mode. According to a particular implementation, the BIOS may affirmatively disable components subject to a recall and otherwise engage a safety mode of operation. In another implementation, the BIOS may transmit signals to a chipset in order to facilitate disabling of components subject to a recall and to engage a safety mode of operation. Thus, in the context of a battery recall, for example, to enter a safety mode a BIOS may enable entry of the safety mode by transmitting and/or storing signals to disable a battery (e.g., disconnect battery from power supply to cease charging and/or disconnect battery from device to cease providing power to components) and/or discharge the battery. In this case, the device may still be able to receive power from a different power source, such as from an external power supply, rather than the disabled battery. In the context of a fan of a heat dissipation system, to enter a safety mode of operation, the BIOS may transmit and/or store signals to disable the fan (e.g., disconnect the fan from the power supply to cease reception of power therefrom) and may also transmit signals to other components of the device (e.g., such as to cause other fans to operate at a higher frequency). At times, entry of a safety mode may also include storing a component ID, such as a reference component ID, similar to operation described in conjunction with block 650.

It was briefly noted above that in some cases, it may be desirable to operate, such as consistently with example method 600, to determine whether a device is operating in a safety mode and to, if certain conditions are met, withdraw the device from safety mode, as shown at blocks 675 and 680. Determining whether a device is operating in a safety mode may be accomplished in a number of possible ways. In one example case, a flag or variable, referred to as a component flag variable in conjunction with block 665, may be used in order to indicate that a device is operating in a safety mode. Thus, example method 600 may be such that the BIOS may identify, upon boot up of a device, a component flag variable (e.g., that a device is operating in a safety mode) and, in response thereto, transmit signals to withdraw the device from safety mode. And withdrawing a device from safety mode, as indicated by block 680, may comprise reversing actions taken previously, such as at block 670. For instance, if a battery is disabled as part of a safety mode of operation, then, as shown at block 680, a connection between a battery and a power supply and/or the battery and other components of the device may be reestablished. Other analogous actions may be taken based on the particular circumstances.

Thereafter, and as shown at block 685, example method 600 of using a BIOS to identify components subject to recall may be exited.

Thus, it may be possible to identify components subject to a recall using a BIOS of a device. Recall component IDs may be hard-coded into a BIOS (or updated BIOS) and the BIOS may compare a component ID with the recall component IDs. In another case, recall component IDs may be transmitted to a device in a signed blob, such as for security. In response to identification of a component subject to a recall, a safety mode of operation may be started. In the context of a battery of a computing device, the safety mode of operation may include disabling and/or discharging the battery.

What is claimed is:

1. A device comprising a plurality of components and a BIOS to provide an interface between an operating system (OS) of the device and hardware and/or firmware of the device, the device comprising:
a non-volatile memory having instructions stored thereon that are executable by a processor of the device to cause the BIOS to:
determine a component identification (ID) of a component of the plurality of components;
fetch a plurality of recall component IDs;
compare the determined component ID with the plurality of recall component IDs;
in response to a correspondence between the determined component ID and one recall component ID of the plurality of component IDs, transmit signals representing a prompt to place the component of the plurality of components in a safety mode; and
receive signals in response to the prompt and, responsive to the received signals, disable the component of the plurality of components.

2. The device of claim 1, wherein the plurality of recall component IDs are stored in the non-volatile memory.

3. The device of claim 1, wherein the plurality of recall component IDs are fetched from an external source.

4. The device of claim 1, wherein the instructions further comprise instructions that are executable by the processor to cause the activation of a flag indicating safety mode.

5. The device of claim 1, wherein the component ID corresponds to an ID of a battery, and the plurality of recall component IDs correspond to IDs of batteries.

6. The device of claim 5, wherein the safety mode comprises disabling and discharging the battery.

7. The device of claim 1, wherein the non-volatile memory further comprises instructions that are executable by the processor to cause the BIOS to transmit signals to enable communication of signals indicative of the battery safety mode to the OS.

8. The device of claim 1, wherein the non-volatile memory further comprises instructions that are executable by the processor to cause the BIOS to store the determined component ID to the non-volatile memory or another memory.

9. A method of identifying recall components of a device, the method comprising:
executing, using a processor of the device, instructions stored in a non-volatile memory of the device to provide a BIOS, the BIOS to provide an interface between an operating system (OS) of the device and firmware and/or hardware of the device;
determining, using the BIOS, a component identification (ID) for a component of the device;
comparing, using the BIOS, the determined component ID with a plurality of recall component IDs;
in response to a correspondence between the determined component ID and one of the plurality of recall component IDs, transmitting, by the BIOS, signals representing a prompt to enter a safety mode; and
in response to reception of signals received in response to the prompt, initiating, by the BIOS, a safe mode of operation.

10. The method of claim 9 further comprising loading the OS of the device in response to signals received in response to the prompt.

11. The method of claim 9 further comprising receiving updated instructions representing an updated BIOS, and wherein the updated instructions are executed by the processor to compare the determined component ID with the plurality of recall component IDs.

12. The method of claim 11, wherein the plurality of recall component IDs are included within the updated instructions.

13. The method of claim 9, wherein the plurality of recall component IDs are received within a signed blob.

14. A method of identifying a battery for recall, the method comprising:
executing, using a processor of a device, instructions stored in a non-volatile memory of the device to initiate a routine of a BIOS, the BIOS to provide an interface between an operating system (OS) of the device and a hardware and/or firmware of the device;
determining, by the BIOS, a battery identification (ID) of a battery of the device;
fetching, by the BIOS, a battery reference ID stored in the non-volatile memory, the battery reference ID corresponding to a battery ID determined previously;
comparing, by the BIOS, the determined battery ID and the fetched battery reference ID;
in response to a determination that the determined battery ID and the fetched battery reference ID do not correspond, fetching, by the BIOS, a list of recall battery IDs stored in the non-volatile memory of the device;
comparing, by the BIOS, the determined battery ID with the recall battery IDs of the list of recall battery IDs;
in response to a correspondence between the determined battery ID and one recall battery ID of the list of recall battery IDs, transmitting, by the BIOS, signals representing a prompt to enter a battery safety mode; and
in response to signals received responsive to the prompt, using the BIOS to enable disabling and discharging the battery such that power to the device may be received from an external power supply rather than the battery.

15. The method of claim 14, wherein the routine of the BIOS further comprises storing a component flag variable in conjunction with entry of the battery safety mode.
